(19) United States
(12) Patent Application Publication
(10) Pub. No.: US 2025/0036490 A1
(43) Pub. Date: Jan. 30, 2025

(54) SYSTEM, METHOD AND COMPUTER-ACCESSIBLE MEDIUM FOR A ZERO-COPY DATA-COHERENT SHARED-MEMORY INTER-PROCESS COMMUNICATION SYSTEM

(71) Applicant: New York University in Abu Dhabi Corporation, Saadiyat Island (AE)

(72) Inventor: Benoit Joseph Lucien MARCHAND, Saadiyat Island (AE)

(73) Assignee: New York University in Abu Dhabi Corporation, Saadiyat Island (AE)

(21) Appl. No.: 18/908,407

(22) Filed: Oct. 7, 2024

Related U.S. Application Data
(63) Continuation of application No. PCT/IB2023/053495, filed on Apr. 5, 2023.
(60) Provisional application No. 63/327,935, filed on Apr. 6, 2022.

(51) Int. Cl. G06F 9/54; G06F 9/52

(52) U.S. Cl. CPC G06F 9/541; G06F 9/52; G06F 9/544

(57) ABSTRACT

Exemplary systems, methods and computer-accessible medium according to exemplary embodiments of the present disclosure can be used to implement a zero-copy data-coherent shared-memory IPC data exchange mechanism. The exemplary procedures, systems, computer accessible medium and/or methods can operate standalone or in combination with underlaying IPC tools. When combined with underlying tools, the exemplary systems, methods and computer-accessible medium does not need to implement the same IPC tool standard. The exemplary procedures, system and/or methods can implement an IPC tool in its entirety, or partially, and it can add functionality to existing IPC tools. The exemplary procedures, system and/or methods can implement a shared memory buffer mechanism, where both a sender process and a receiver process use the same shared memory space. Both the sender process and receiver process buffers can be overlayed by the shared memory space where the shared memory space is mapped over the virtual address space of the sender buffer space and/or receiver buffer space.

### CROSS-REFERENCE TO RELATED APPLICATION(S)

This application relates to and claims priority from U.S. Patent Application No. 63/327,935, filed on Apr. 6, 2022, the entire disclosure of which is incorporated herein by reference.

### FIELD OF DISCLOSURE

The present disclosure relates generally to inter-process communication mechanisms, and more specifically, to exemplary embodiments of exemplary system, method and computer-accessible medium for a zero-copy data-coherent shared-memory inter-process communication mechanism.

### BACKGROUND INFORMATION

In the field of computing, at times, there may be a need to enable independently running processes to exchange information with one another (e.g., distributed computing). Procedures for facilitating such exchange of information is studied in the field of inter-process communication (IPC) mechanisms. While some IPC tools may be limited to intra-node communications—where all processes can run on the same computer node—other IPC tools allow communicating parties to reside on different nodes (e.g., inter-node communication), and/or on the same node (e.g., intra-node communication). The most common IPC standard is MPI (Message Passing Interface) used widely throughput the industrial, governmental, academic, and scientific market sectors. The use of IPC tools is related to High Performance Computing (HPC), a $14 B industry in 2021.

Currently, there is no known IPC tool which supports both intra-node and inter-node communications that can enable zero-copy data exchanges for intra-node communications. For instance, MPI can support intra-node communications through shared memory in a variety of ways, some copying user data twice (from the sender's buffer to a shared memory buffer, and from this buffer to the receiver's buffer), and others copying data once. The one-copy mechanisms can use a kernel system call to export a user space sender process buffer to a shared memory address which the receiver process can then access—this technique is known as cross-memory attach; such mechanisms are found in XPMEM, KNEM, CMA shared memory transport modules in common MPI implementations. Some of these one-copy mechanisms are improperly advertised as “zero-copy” capable, for instance MPI's “VADER” BTL (Byte Transfer Layer).

While MPI tools provide implicit synchronization mechanism to ensure data coherency, current zero-copy shared-memory-only IPC tools do not protect data coherency such that a receiver process must wait until a sender process has completed using the data to send and won't access the data again until after the receiver finished using the data.

Moreover, current intra-node IPC tools of all types exchange data between sender process and receiver processes using a shared memory mechanism. For example, they do not use the user space sender process or receiver process buffers.

Thus, it may be beneficial to provide an exemplary system, method, and computer-accessible medium for inter-process communication mechanisms which can overcome at least some of the deficiencies described herein above. For example, it may be beneficial to provide an exemplary system, method and computer-accessible medium for facilitating the use of zero-copy data-coherent shared-memory IPC exchanges which can be combined with existing IPC tools to supplement their functionality.

### SUMMARY OF EXEMPLARY EMBODIMENTS

According to the exemplary embodiments of the present disclosure, the term shared-memory or intra-node communications can describe any computer arrangement with processors that have access to a shared memory mechanism be it through a memory hardware component, e.g., DDR4 ram—on a computer node, a reflective memory hardware component connecting more than one computer node, or a software mechanism virtualizing memory across multiple computer nodes (e.g., virtualized distributed memory) using technologies such as RDMA (Remote Direct Memory Access—a feature of most interconnect hardware).

The present disclosure relates to exemplary system, method and computer-accessible medium to implement a zero-copy data-coherent shared-memory intra-node IPC mechanism. Exemplary systems, method sand computer-accessible medium can optimize performance of shared-memory data exchanges, while being transparent to non-shared-memory data exchanges.

Exemplary systems, methods and computer-accessible medium according to exemplary embodiments of the present disclosure can provide applications with an IPC API (application programming interface) that is a superset of existing IPC standards, such as, for example, MPI. Thus, an exemplary embodiment of the present disclosure can be built on top of existing IPC tools, such as MPI, without requiring any changes to the underlying IPC tools. The underlying IPC tools may not be aware that they are being combined with the present zero-copy data-coherent shared-memory IPC mechanism.

Exemplary systems, methods and computer-accessible medium, according to exemplary embodiments of the present disclosure can be combined with underlying IPC tools such that—some or all—intra-node IPC calls are redirected to the present disclosure IPC mechanism, and the inter-node IPC calls are redirected to the underlying IPC mechanism.

Furthermore, the redirection of IPC calls to the present disclosure's IPC mechanism and/or underlying IPC mechanism, in an exemplary embodiment, can be transparent to the application. For example, the application may not be aware that its IPC calls may be redirected to one or another IPC mechanism.

Exemplary systems, methods and computer-accessible medium, according to exemplary embodiments of the present disclosure can also standalone and operate on its own without an underlying IPC tool to perform intra-node IPC functions.

Exemplary systems, methods and computer-accessible medium according to exemplary embodiments of the present disclosure can further facilitate zero-copy data exchanges between sender and receiver processes without the use of a cross-memory attach mechanism specific system calls—such as those found in XPMEM, CMA, and KNEM.

Exemplary systems, methods and computer-accessible medium according to exemplary embodiments of the present disclosure can operate without the addition of kernel modules within the operating system, e.g., relying solely on ISO 23360 (Linux Standard Base ISO standard) functionality.

Exemplary systems, methods and computer-accessible medium according to exemplary embodiments of the present disclosure can facilitate a user space virtual memory region to be used by a sender process as a shared memory region, thereby eliminating the need for the IPC mechanism to copy a sender process buffer data to a shared memory region.

Exemplary systems, methods and computer-accessible medium according to exemplary embodiments of the present disclosure can facilitate a user space virtual memory region to be used by a receiver process as a shared memory region, thereby eliminating the need for the IPC mechanism to copy sender process data from the shared memory region into a receiver process buffer.

Exemplary systems, methods and computer-accessible medium according to exemplary embodiments of the present disclosure can facilitate both a sender process and a receiver process user space virtual memory region to be used simultaneously as a shared memory region such that whenever a sender process writes data into its user space buffer the receiver process can have access to the sender process data in its own user space buffer.

Exemplary systems, methods and computer-accessible medium according to exemplary embodiments of the present disclosure can perform IPC operations directly from a sender process—or receiver process—user space buffer without the application being aware.

An exemplary embodiment of the present disclosure can be based on a two-phase synchronization mechanism instead of the single-phase synchronization mechanism implemented in existing IPC tools—such as PVM, and MPI.

The exemplary utilization of a two-phase synchronization mechanism extend the underlying IPC tool API. The API extension is visible to the application through the redirection mechanism described above. And the API extension can be cancelled out for API calls not redirected to the mechanism above, and thus, underlying IPC tools may not be aware of the exemplary mechanism operation—e.g., transparent to the underlying IPC tool.

The exemplary utilization of the two-phase synchronization mechanism can improve distributed application performance through the use of light-weight shared-memory synchronization functions available in operating systems and/or specialized libraries.

The exemplary utilization of the two-phase synchronization mechanism can also improve distributed application parallelism because it can relax process coupling—e.g., loosely coupled parallelism instead of tightly coupled parallelism.

Exemplary system, method and computer-accessible medium, according to exemplary embodiments of the present disclosure, can further optimize IPC exchanges by incorporating a process placement optimization mechanism, and/or a non-uniform memory access (“NUMA”)/cache placement mechanism, and/or NUMA/cache migration optimization mechanism, such that, for example, sender and receiver processes share the same—or close-by—NUMA/cache components while performing the IPC exchanges.

Exemplary systems, methods and computer-accessible medium according to exemplary embodiments of the present disclosure can further optimize IPC exchanges by incorporating a process optimization mechanism which can control process bindings to processor core(s) and process priorities.

Exemplary systems, methods and computer-accessible medium according to exemplary embodiments of the present disclosure can further optimize IPC exchanges by incorporating a processor optimization mechanism which can control processor cache to memory bandwidth allocation, and/or processor cache allocation—for example Intel's MBA (Memory Bandwidth Allocation) and CAT (Cache Allocation Technology).

These and other objects, features and advantages of the exemplary embodiments of the present disclosure will become apparent upon reading the following detailed description of the exemplary embodiments of the present disclosure, when taken in conjunction with the accompanying claims.

### BRIEF DESCRIPTION OF THE DRAWINGS

Further objects, features and advantages of the present disclosure will become apparent from the following detailed description taken in conjunction with the accompanying Figures showing illustrative embodiments of the present disclosure, in which:

FIG. 1a is a diagram of a shared memory message passing exchange without synchronization between two processes;

FIG. 1b is a diagram of a shared memory message passing exchange with synchronization between two processes;

FIG. 2a is a diagram of an intra-node MPI message passing exchange using shared memory between two processes;

FIG. 2b is a diagram of an intra-node MPI message passing exchange using a single-copy shared memory mechanism between two processes.

FIG. 3 is a diagram of a configuration according to an exemplary embodiment of the present disclosure for a zero-copy shared-memory message passing exchange between two processes;

FIG. 4 is a diagram of a coding implementation configuration according to an exemplary embodiment of the present disclosure for a zero-copy shared-memory a message passing exchange between two processes and its impact on performance;

FIG. 5 is a diagram of a coding implementation according to an exemplary embodiment of the present disclosure where the disclosure's API is a superset of the underlying IPC tool API;

FIG. 6 is a diagram of an implementation of an exemplary embodiment of the present disclosure where the zero-copy mechanism maps a shared virtual address space over user application private address space;

FIG. 7 is a graph of a memory bandwidth usage while performing a halo communication test according to an exemplary embodiment of the present disclosure;

FIG. 8 is a graph of the scalability and speedup while performing a halo communication test obtained by exemplary methods, system and computer-accessible medium according to an exemplary embodiment of the present disclosure; and

FIG. 9 is an illustration of an exemplary block diagram of an exemplary system in accordance with certain exemplary embodiments of the present disclosure.

Throughout the drawings, the same reference numerals and characters, unless otherwise stated, are used to denote like features, elements, components, or portions of the illustrated embodiments. Moreover, while the present disclosure will now be described in detail with reference to the figures, it is done so in connection with the illustrative embodiments and is not limited by the particular embodiments illustrated in the figures and accompanying claims.

### DETAILED DESCRIPTION OF THE EXEMPLARY EMBODIMENTS

The exemplary systems, methods and computer-accessible medium according to an exemplary embodiment of the present disclosure can be used to implement a zero-copy data-coherent shared-memory IPC exchange such that applications can benefit from the combined capabilities of the present disclosure and an underlying IPC tool to improve application intra-node IPC performance while using the unmodified underlying IPC tool for non-shared-memory communication exchanges.

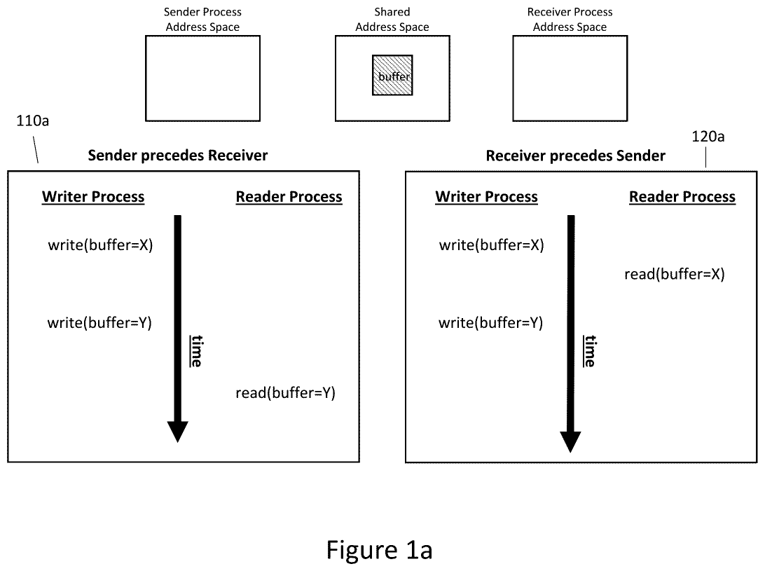

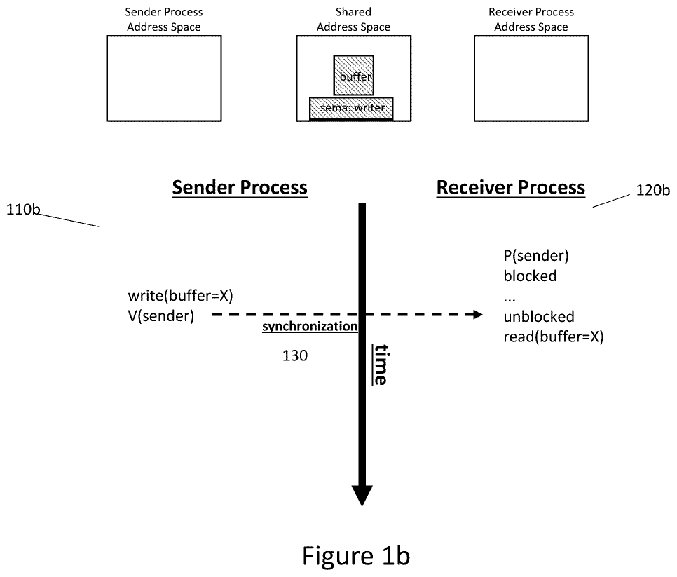

FIG. 1a illustrates the use of shared memory for data exchanges without synchronization. As can be seen in FIG. 1a, the end result of a sender-receiver processes 110a, 120a exchange depends on the execution order. Thus, such exemplary exchanges may not preserve data coherency and applications can't guarantee result correctness.

In the exemplary embodiments of the present disclosure, the P( ) and V(semaphore notation can be used to denote a synchronization. As such, P(x) can be used to denote a process waiting on a variable “x” to be set, and V(x) is used to denote a process setting variable “x”. For example, the use of the “semaphore” P( ) and V( ) notation can mean an increase of readability, and does not preclude the use of any other low-level synchronization mechanism, including busy-wait-loop synchronization.

FIG. 1b shows the use of shared memory for data exchanges with an explicit synchronization 130 between a sender process 110b and a receiver process 120b. The receiver process 120b can execute a P(sender) operation to wait until the sender process 110a has executed a matching V(sender) operation. Thus, the receiver process 120b can be ensured to, e.g., always receive a valid buffer value, which can be a coherent data exchange.

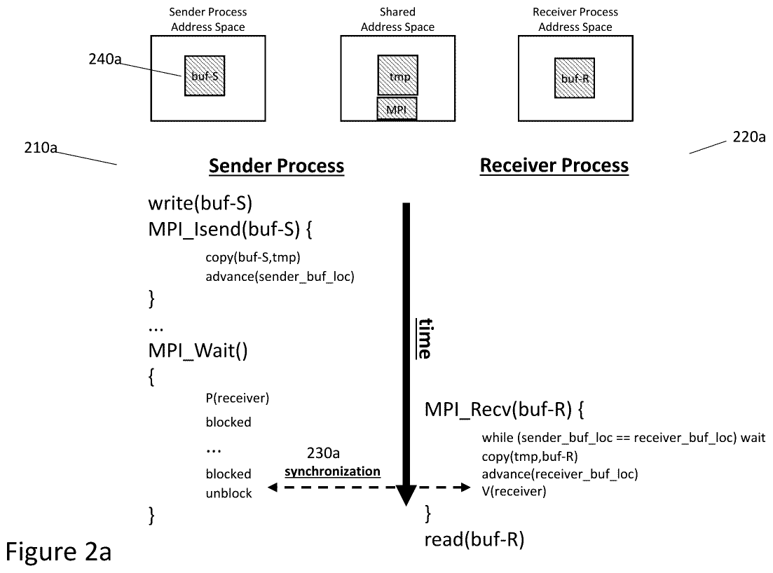

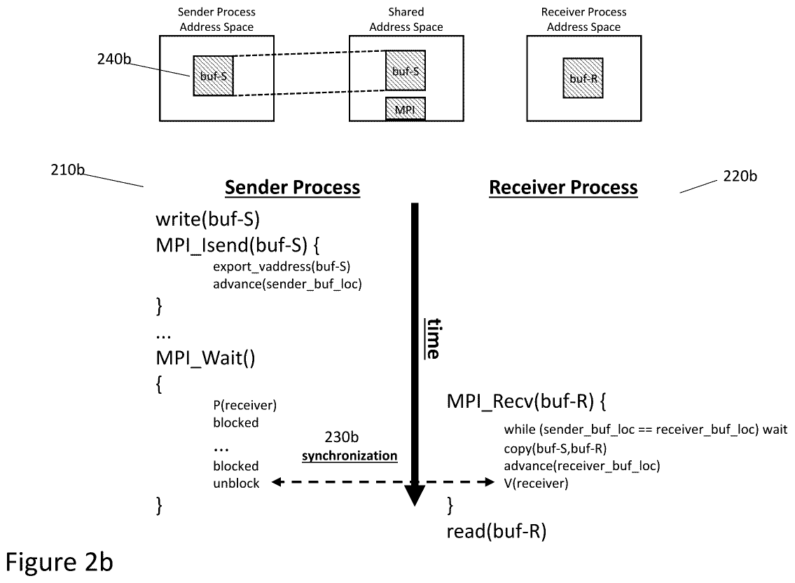

FIG. 2a illustrates the exemplary scenario of FIG. 1b in which the sender process 210a and the receiver process 220a are not using a shared memory transport—e.g., MPI's BTL—although they could be running on the same compute node. In this example, the internal operation of MPI_Isend, MPI_Wait, and MPI_Recv are simplified for the purpose of demonstration. The sender process 220a blocks until the receiver process 220b has received the sender's data, and between the MPI_Isend and MPI_Wait calls, the sender process 220a is not permitted to modify the data sent to preserve data coherency.

As can be seen in FIG. 2a, the V(receiver) operation of the receiver process 220b can indicate to the sender process 220a, e.g., two distinct synchronization conditions. First, it can indicate to the sender process 220a that its buffer 240a can again be used safely. Second, it can indicate the completion of the data exchange to the sender process 220a. These two distinct conditions are embodied by a single phase of synchronization 230a. Such single-phase synchronization can be the way IPC tools normally operate, including all MPI variants abiding by the MPI standard.

FIG. 2b shows the exemplary scenario of FIG. 2a that uses single-copy shared-memory cross-memory-attach mechanisms, e.g., CMA, KNEM, XPMEM. As can be seen in FIG. 2b, the only difference is that rather than copying the data of the sender process 210b into a shared memory buffer 240b, the cross-memory-attach mechanism exports—through Linux mmap or a specific system call which registers the physical memory location of the buffer 240b-virtual address space region into the shared memory address space. Thus, part of the virtual address space of the sender process 210a can now be accessible to the receiver process 220b.

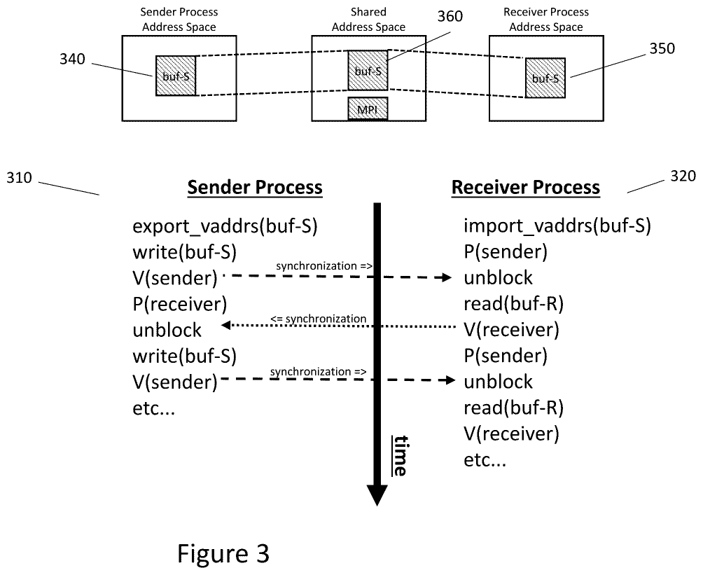

FIG. 3 illustrates an exemplary diagram of an implementation of an exemplary embodiment of the present disclosure for performing an exchange between a sender process 310 and a receiver process 320. Such exemplary implementation can use a zero-copy data-coherent shared-memory IPC exchange. Further, both exemplary processes can have part of their virtual address space—e.g., the sender buffer and receiver buffer—mapped to the same memory range (e.g., shared buffer 360) in the shared memory address space.

Moreover, FIG. 3 shows an exemplary diagram providing the exemplary embodiment of the present disclosure which can perform the exchange using a two-phase synchronization mechanism. To the contrary of the single-phase synchronization mechanism used by existing IPC tools—as described above, the exemplary configuration(s) according to the exemplary embodiments of the present disclosure can implement a two-phase synchronization procedure where the signaling of the completion of an operation can be decoupled from the signaling of the readiness of a user buffer to be modified again. Thus, as shown in FIG. 3, there can be a P(sender)—V(sender) synchronization phase for access to the sender's buffer 340, and a separate P(receiver)—V(receiver) synchronization phase for completion of the exchange operation.

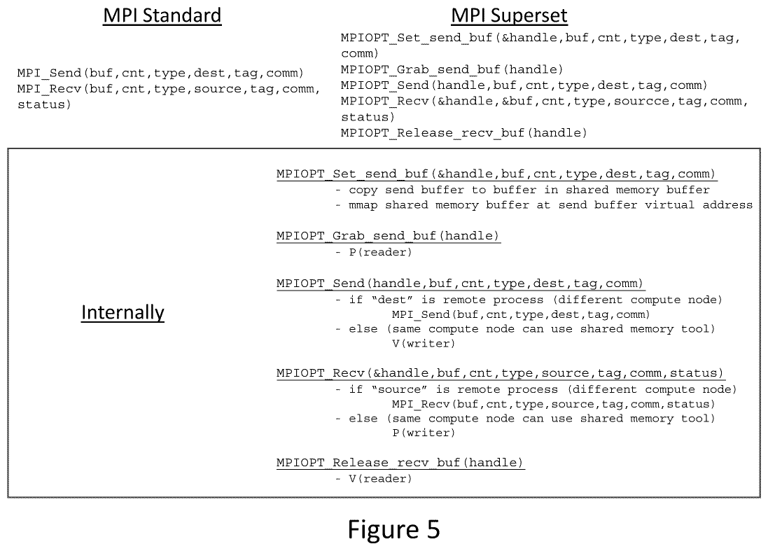

FIG. 5 illustrates method and configuration according to an exemplary embodiment of the present disclosure where the IPC API—in this example MPI—is extended to (a) implement the zero-copy function (MPIOPT_Set_send_buf), and (b) implement the two-phase synchronization (MPIOPT_Grab_send_buf and MPIOPT_Send). In this examplary embodiment, the API extension can be a superset of the MPI standard which either redirects exchanges through the present disclosure mechanism or through the underlying IPC tool—without the latter's awareness. And when the underlying IPC tool is used to perform the exchange the MPIOPT_Grab_send_buf function (e.g., synchronization phase related to the sender process buffer access) can be cancelled out.

In particular, in FIG. 5, the sender process call to MPIOPT_Set_send_buf can map a segment of the shared memory address space to overlay the sender process' buffer virtual address range. Accordingly, in one exemplary embodiment of the present disclosure, when the sender process accesses its send buffer, it actually accesses a shared memory region instead of its original buffer memory space. This exemplary process is the reverse of cross-memory-attach mechanisms when the sender process virtual address space is exported to the shared memory—e.g., the sender process uses its original memory when it accesses its send buffer.

Further, in FIG. 5, the receiver process can complete the exchange with the sender process send buffer through the MPIOPT_Recv call—at which time the source process of the exchange may be known. It should be noted that in another exemplary embodiment of the present disclosure, the receiver process may choose not to attach its “recv” buffer to the sender process “send” buffer, but it can return instead the virtual address of the shared memory region where the send buffer resides, thus still can implement a zero-copy shared memory exchange.

As illustrated in the exemplary coding implementation of FIG. 5, the exchange completion synchronization phase can be implemented through MPIOPT_Send—V(writer) and MPIOPT_Recv—P(writer), while the sender buffer usage synchronization can be implemented through MPIOPT_Grab_send_buf—P(reader) and MPIOPT_Release_recv_buf—V(reader).

The systems, method and computer-accessible medium according to exemplary embodiment of the present disclosure can use light weight synchronization primitives readily available from the operating system, and/or specialized libraries, and/or busy-wait-loop methods. For example, Linux semaphores can be used to perform the two-phase synchronization. Semaphores can be very efficient and execute much faster than an IPC tool Send/Recv exchange can perform. Thus, in an exemplary embodiment of the present disclosure, the two-phase synchronization can enhance performance.

Moreover, the two-phase synchronization mechanism described above can also increase performance because it decouples two distinct synchronization events, thus relaxing process coupling—e.g., loosely coupled parallelism instead of tightly coupled parallelism.

As shown in FIG. 1, e.g., to maintain data coherency where the sender process buffer lies in the same physical memory location as the receiver process buffer a zero-copy shared-memory IPC mechanism requires a different synchronization mechanism. The one-phase synchronization method used in other IPC mechanisms, such as, for example, MPI, may be insufficient as the termination of an MPI_Send or MPI_Wait (following an MPI_Isend) may not guarantee that it is safe for the sender process to modify its sender buffer, not knowing whether the receiver process is done with using the shared buffer. However, a one-phase synchronization mechanism could work with MPI if a receiver process could notify that it is done with using the shared sender-receiver buffer. This may require altering the MPI standard, so that MPI_Recv/MPI_Irecv only completes the transfer on the receiver process side while holding the sender process blocked until the receiver calls another MPI function to release the buffer. But this mechanism too is actually a two-phase synchronization method (e.g., end of receive event and end of buffer use event). Moreover, such a method may be slow—holding the sender process until the receiver is done with the buffer, and it may require extensive rework of MPI implementations. Thus, an exemplary embodiment of the present disclosure can include or facilitate a two-phase synchronization mechanism, which can differentiate between an end-of-exchange event and an end-of-buffer-use event, to implement a zero-copy data-coherent shared-memory IPC mechanism.

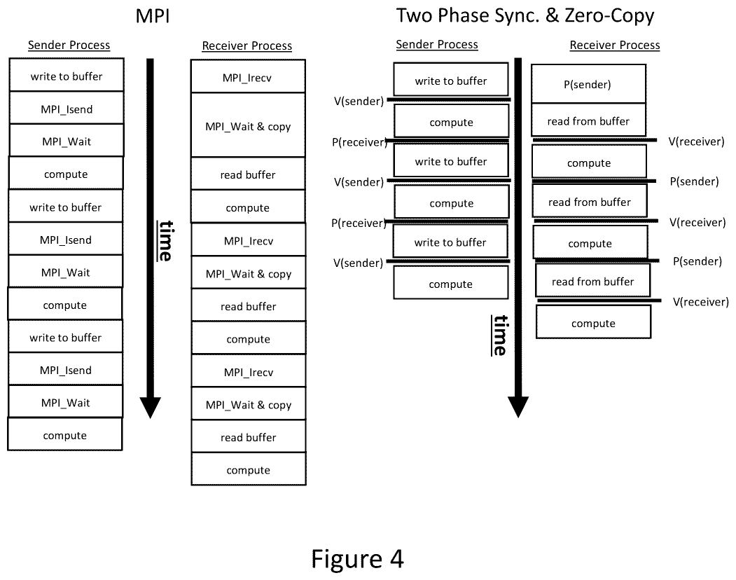

FIG. 4, illustrates a diagram of an exemplary implementation of an exemplary embodiment of the present disclosure implementing a two-phase synchronization mechanism and compares it to MPI. In one example, all operations are deemed to require the same time to execute except for the light weight semaphore operations—which is a much faster operation. As can be seen in both cases, when the sender process is computing the receiver process is using the sender's buffer, and when the receiver process is computing, the sender is updating its buffer. The difference lies in the fact that MPI_Irecv,MPI_Isend, and MPI_Wait are expensive operations, and MPI_Wait blocks the receiver process while the MPI_Isend is completed. And while MPI_Wait blocks the sender process, the receiver process completes copying the sender process data from the shared memory region.

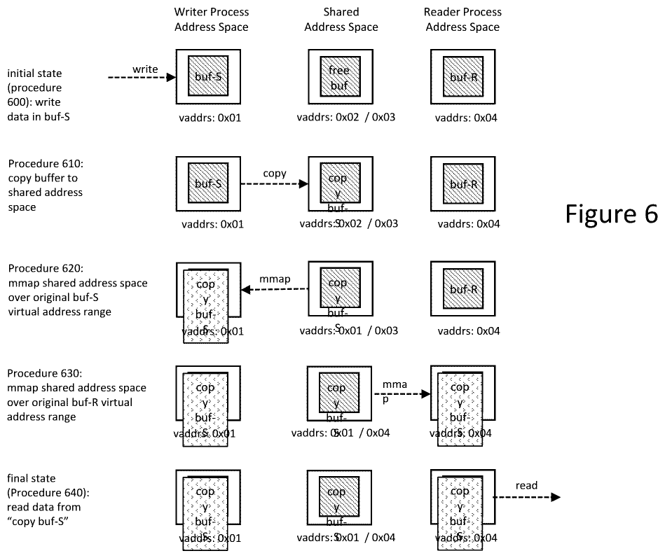

FIG. 6 illustrates a diagram of an exemplary implementation of an exemplary embodiment of the present disclosure, in which the sender process and the receiver process overlay the same part of the shared memory address space—the part containing the communication buffer—over their respective “send” and “recv” buffers to perform a zero-copy exchange. As shown in FIG. 6, the sender process can write data in its own data buffer as usual. In particular, initially, data can be written in buffer buf-S (procedure 600). In procedure 610, the sender process can copy part of its address space—the part containing its buffer aligned on page boundaries—to the shared memory. In procedure 620, the sender process can overlay (e.g., Linux fixed address mmap) the shared memory space back over its own send buffer space (page aligned). In procedure 630, the receiver process can overlay (e.g., Linux fixed address mmap) the same shared memory space over its own receive buffer space. At this point the sender process send buffer can be shared with the receiver process receive buffer space through the shared memory region without the sender process or the receiver process being aware or having required any modification, recompiling, or relinking. For example, the virtual address changes to the shared memory buffer space while the user buffers address space remains the same throughout. The shared memory buffer space virtual address changes to that of the sender process send buffer virtual address, while the same shared memory buffer space virtual address changes to that of the receiver buffer virtual address space, and both the sender process send buffer and the receiver process receive buffer maintain their original virtual address space. This exemplary process can ensure that the applications need not be modified, recompiled, or relinked as there are no changes as far as the applications are concerned—e.g., application is unaware of the memory overlay. In procedure 640, the receiver process can access its own receive buffer as usual. The exemplary result can be that the sender process has effectively exchanged data with the receiver process while no data was copied.

In another exemplary embodiment of the present disclosure, a similar zero-copy mechanism can be devised where the receiver process may not overlay (e.g., Linux fixed address mmap) its receive buffer over the shared memory buffer virtual address space. In yet another exemplary embodiment of the present disclosure a similar zero-copy mechanism can be devised where the sender process does not overlay (e.g., Linux fixed address mmap) its send buffer over the shared memory buffer virtual address space.

As can be seen in the exemplary embodiment above, no cross-memory-attach tool (ex.: KNEM, XPMEM, CMA) specific system call are required, nor is there a need for a tool-specific kernel module to be loaded. All operations described herein rely solely on ISO 23360 (Linux Standard Base ISO standard) functionality.

In yet another exemplary embodiment of the present disclosure, IPC exchanges can be optimized by incorporating a process placement optimization mechanism, and/or a NUMA memory allocation policy, and/or a cache placement policy, and/or a cache allocation policy, and/or a cache bandwidth allocation policy such that, for example, sender and receiver processes share the same—or close-by—NUMA and cache components while performing IPC exchanges.

As an exemplary embodiment of the present disclosure can control intra-node IPC exchanges, it can also track, analyze and optimize system operation.

Moreover, according to an exemplary embodiment of the present disclosure, it is possible to receive information about expected IPC exchanges from a higher-level tool, such as described in U.S. Patent Application Ser. No. 618,797 filed on Dec. 13, 2021 entitled “SYSTEM, METHOD AND COMPUTER-ACCESSIBLE MEDIUM FOR A DOMAIN DECOMPOSITION AWARE PROCESSOR ASSIGNMENT IN MULTICORE PROCESSING SYSTEM(S)” and/or U.S. Patent Application Ser. No. 63/320,806 filed on Mar. 17, 2022 entitled “SYSTEM, METHOD AND COMPUTER-ACCESSIBLE MEDIUM FOR AN INTER-PROCESS COMMUNICATION TOOLS COUPLING SYSTEM”, and proceed to set process core, memory, bandwidth, cache, etc., policies to optimize intra-node IPC performance based on the information received from such mechanisms. The present applications, along with these exemplary patent applications also describe and cover exemplary communication path optimization methods, system and computer-accessible medium configured to optimize memory bandwidth utilization and/or interconnect bandwidth utilization while performing data transfers and/or synchronization operations to perform point-to-point communications between processes.

For example, according to an exemplary embodiment of the present disclosure, it is possible to use ISO 23360 (Linux Standard Base ISO standard) features to control process binding to one or a plurality of processor cores, to control NUMA memory allocation to one or a plurality of NUMA nodes, to control NUMA memory migration from one or more NUMA nodes to one or more NUMA nodes, to control process scheduling priority, etc. Additionally, according to the exemplary embodiments of the present disclosure, it is possible to use external libraries, and/or internal code, and/or possible future extensions to ISO 23360, to control cache to memory bandwidth use, and/or to control cache allocation, through processor features such as Intel's CAT (Cache Allocation Technology) and MBA (Memory Bandwidth Allocation).

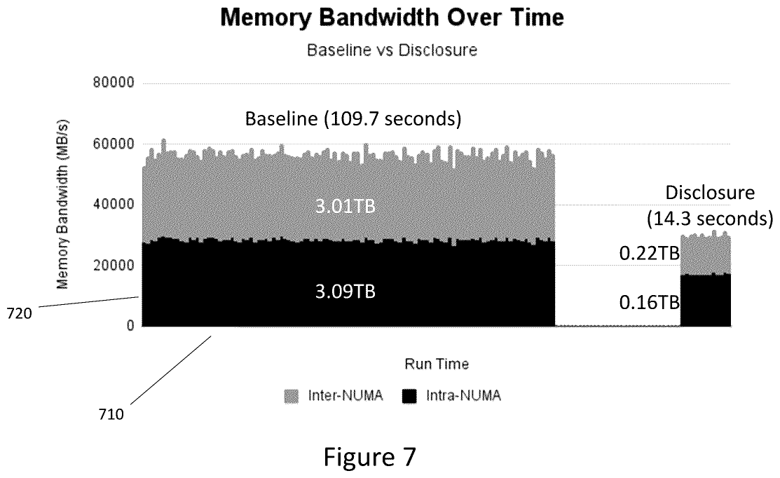

FIG. 7 illustrates an exemplary graph of the exemplary performance impact of exemplary systems, methods and computer-accessible medium according to an exemplary embodiment of the present disclosure on a 2D Halo Ping-Pong test running on a 128 cores compute node (2×AMD 7742-8 NUMA nodes with 16 cores each). For example, a 2D Halo Ping-Pong test simulates the data transfers between processes on most distributed application; each process exchanges data with its 4 nearest neighbors. In this example, the “baseline” uses HPC-X 4.1.1rc2 MPI from Mellanox, and the “disclosure” uses the zero-copy data-coherent shared-memory mechanism according to the exemplary embodiments of the present disclosure as shown in FIGS. 3, 4, 5 and 6, implementing a superset of MPI's MPI_Isend/Irecv and MPI_Wait. Furthermore, the exemplary embodiment implements a process placement, and a NUMA placement policy such that IPC exchanges reduce, to the extent possible, inter-NUMA memory traffic.

The X-axis 710 of FIG. 7 represents the run-time of each test, and the Y-axis 720 represents the memory bandwidth (both intra-NUMA node and inter-NUMA node memory bandwidth) measured at each second throughout execution. The “baseline” ran in 109.7 seconds and required 6.1 TB of memory traffic, while the “disclosure” test ran in 14.3 seconds and required 0.38 TB of memory traffic. This test demonstrates that exemplary embodiments of the present disclosure can allow for substantial performance gains to be obtained with minimal application modifications, and no underlaying MPI modifications. Moreover, the effort required to develop a similar IPC method was less than 1 man-month of coding—HPC-X MPI, by comparison, is estimated to be several thousand man-years of coding effort.

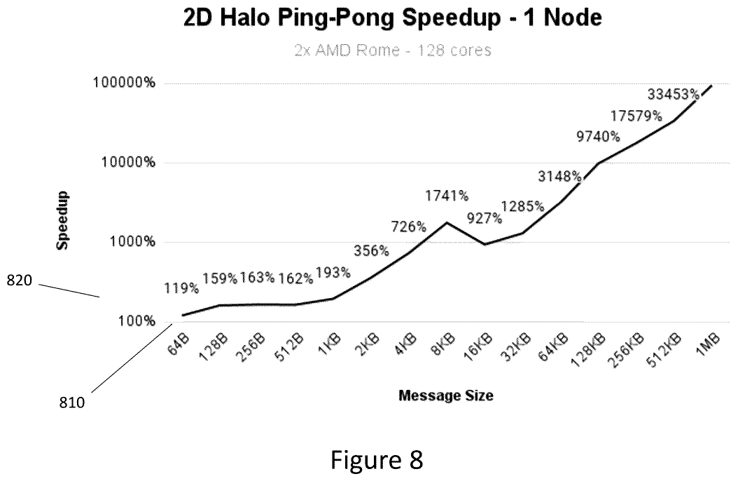

FIG. 8 shows an exemplary graph of the exemplary speedup and scalability of the same test as illustrated in the exemplary graph of FIG. 7. The test was scaled from 64 byte (B) transfers to 1 mega-byte (MB) transfers by increments of 2×. The X-axis 810 in FIG. 8 represents the transfer size, and the Y-axis 820 represents the speedup (logarithmic scale). The exemplary system can be between one and two orders of magnitude faster than HPC-X—presently the fastest exemplary MPI implementation.

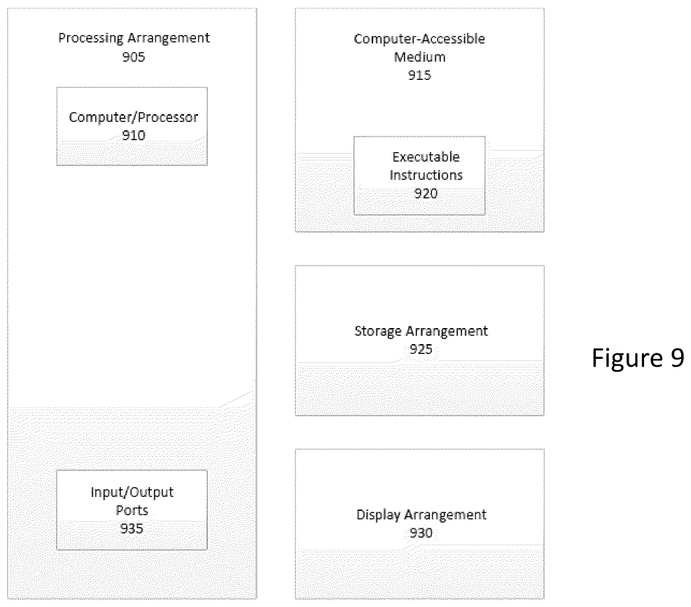

FIG. 9 illustrates a block diagram of an exemplary embodiment of a system according to the present disclosure. For example, exemplary procedures in accordance with the present disclosure described herein can be performed by a processing arrangement and/or a computing arrangement (e.g., computer hardware arrangement) 905. Such processing/computing arrangement 905 can be, for example entirely or a part of, or include, but not limited to, a computer/processor 910 that can include, for example one or more microprocessors, and use instructions stored on a computer-accessible medium (e.g., RAM, ROM, hard drive, or other storage device).

As shown in FIG. 9, for example a computer-accessible medium 915 (e.g., as described herein above, a storage device such as a hard disk, floppy disk, memory stick, CD-ROM, RAM, ROM, etc., or a collection thereof) can be provided (e.g., in communication with the processing arrangement 905). The computer-accessible medium 915 can contain executable instructions 920 thereon. In addition or alternatively, a storage arrangement 925 can be provided separately from the computer-accessible medium 915, which can provide the instructions to the processing arrangement 905 so as to configure the processing arrangement to execute certain exemplary procedures, processes, and methods, as described herein above, for example.

Further, the exemplary processing arrangement 905 can be provided with or include an input/output ports 935, which can include, for example a wired network, a wireless network, the internet, an intranet, a data collection probe, a sensor, etc. As shown in FIG. 9, the exemplary processing arrangement 905 can be in communication with an exemplary display arrangement 930, which, according to certain exemplary embodiments of the present disclosure, can be a touch-screen configured for inputting information to the processing arrangement in addition to outputting information from the processing arrangement, for example. Further, the exemplary display arrangement 930 and/or a storage arrangement 925 can be used to display and/or store data in a user-accessible format and/or user-readable format.

The foregoing merely illustrates the principles of the disclosure. Various modifications and alterations to the described embodiments will be apparent to those skilled in the art in view of the teachings herein. It will thus be appreciated that those skilled in the art will be able to devise numerous systems, arrangements, and procedures which, although not explicitly shown or described herein, embody the principles of the disclosure and can be thus within the spirit and scope of the disclosure. Various different exemplary embodiments can be used together with one another, as well as interchangeably therewith, as should be understood by those having ordinary skill in the art. In addition, certain terms used in the present disclosure, including the specification, drawings and claims thereof, can be used synonymously in certain instances, including, but not limited to, for example, data and information. It should be understood that, while these words, and/or other words that can be synonymous to one another, can be used synonymously herein, that there can be instances when such words can be intended to not be used synonymously. Further, to the extent that the prior art knowledge has not been explicitly incorporated by reference herein above, it is explicitly incorporated herein in its entirety. All publications referenced are incorporated herein by reference in their entireties.

### EXEMPLARY REFERENCES

The following references are hereby incorporated by reference, in their entireties:
1) https://www.open-mpi.org/
2) https://www.mpich.org/
3) https://mvapich.cse.ohio-state.edu/
4) https://developer.nvidia.com/networking/hpc-x
5) https://www.hpe.com/psnow/doc/a00074669en_us
6) https://www.mcs.anl.gov/research/projects/mpi/standard.html
7) https://www.csm.ornl.gov/pvm/
8) https:/en.wikipedia.org/wiki/Distributed_object_communication
9) https:/en.wikipedia.org/wiki/Remote_procedure_call
10) https:/en.wikipedia.org/wiki/Memory-mapped_file
11) https:/en.wikipedia.org/wiki/Message_Passing_Interface
12) https://juliapackages.com/p/mpi
13) https://www.mathworks.com/help/parallel-computing/mpilibconf.html
14) https://opam.ocaml.org/packages/mpi/
15) https://pari.math.u-bordeaux.fr/dochtml/html/Parallel_programming.html
16) https://hpc.llnl.gov/sites/default/files/pyMPI.pdf
17) https://cran.r-project.org/web/packages/Rmpi/Rmpi.pdf
18) https://www.eclipse.org/community/eclipse_newsletter/2019/december/4.php
19) https://blogs.cisco.com/performance/the-vader-shared-memory-transport-in-open-mpi-now-featuring-3-flavors-of-zero-copy
20) https://www.researchgate.net/publication/266659710_Benefits_of_Cross_Memory_Attach_for_MPI_libraries_on_HPC_Clusters
21) https://code.google.com/archive/p/xpmem/
22) https://hal.inria.fr/hal-00731714/document
23) https://pc2lab.cec.miamioh.edu/raodm/pubs/confs/pads18.pdf
24) https://access.redhat.com/documentation/en-us/red_hat_enterprise_linux/6/html/6.3_release_notes/kernel
25) https://www.ibm.com/docs/en/aix/7.2?topic=services-cross-memory-kernel
26) https://www.intel.com/content/www/us/en/developer/articles/technical/introduction-to-memory-bandwidth-allocation.html
27) https://www.intel.com/content/www/us/en/developer/articles/technical/introduction-to-cache-allocation-technology.html

1. A method for facilitating an inter-process communication (“IPC”) of a plurality of IPC processes or tools, comprising:
using a two-phase synchronization mechanism, sharing a memory segment between a sender process buffer of a first IPC process or tool and a receiver process buffer of a second IPC process or tool,
wherein the two-phase synchronization mechanism is based on at least one of (i) a completion of the IPC, or (ii) a termination of the IPC using the shared memory segment for at least one of a reading procedure or a writing procedure.

2. The method of claim 1, wherein the IPC is configured to exclude data copying.

3. The method of claim 1, wherein the IPC is configured to operate independently from (i) the first IPC process or tool, and (ii) the second IPC process or tool.

4. The method of claim 1, wherein the IPC is configured to operate independently from an underlying application.

5. The method of claim 1, wherein the IPC is configured to operate implement a subset of (i) the first IPC process or tool, and (ii) the second IPC process or tool.

6. The method of claim 1, wherein the IPC is configured to add a functionality to (i) the first IPC process or tool, and (ii) the second IPC process or tool.

7. The method of claim 1, wherein the IPC is configured to implement an IPC standard that is different from a standard of (i) the first IPC process or tool, and (ii) the second IPC process or tool.

8. The method of claim 1, wherein the IPC is configured to at least one:
a. intercept IPC function calls,
b. redirect IPC function calls,
c. redirect IPC function calls to (i) the first IPC process or tool, and (ii) the second IPC process or tool,
d. implement a superset of (i) the first IPC process or tool, and (ii) the second IPC process or tool, and redirect function calls to (a) the first IPC process or tool, and (b) the second IPC process or tool so that applications are not aware of redirection process,
e. operate on its own without (i) the first IPC process or tool, and (ii) the second IPC process or tool,
f. require no cross-memory-attach specific system calls,
g. require no embodiment-specific kernel modules,
h. utilize non-specific shared-memory hardware or software arrangements,
i. utilize at least one of physical memory, NUMA memory, reflective memory, or virtualized distributed memory,
j. track, record, analyze, and optimize system operation,
k. implement one or more process optimizations,
l. implement at least one of placement, binding, or priority,
m. implement non-uniform memory access (‘NUMA”) memory optimizations,
n. implement at least one of placement or migration,
o. implement one or more cache memory optimizations, or
p. implement at least one of a physical allocation or a memory bandwidth allocation.

9. The method of claim 1, wherein the sharing the memory procedure at least one:
a. utilizes a shared memory region to hold a single buffer to be used by a sender process and a receiver process for one or more data exchanges,
b. includes a first shared memory region used for the data exchanges by the sender process that overlays an original sender process buffer memory space,
c. includes a second shared memory region used for the data exchanges by the receiver process that overlays an original receiver process buffer memory space,
d. includes a third shared memory region used for exchanges that is overlayed by the sender process and the receiver process concurrently,
e. excludes the sender process and the receiver processes which are not aware of a memory overlay process, or
f. utilizes a reverse process with one or more cross-memory-attach methods, wherein an original user buffer space overlays the shared memory region.

10. The method of claim 1, wherein the two-phase synchronization mechanism is configured to at least one of:
a. implement a separate synchronization event for at least one of a data exchange, a sender process or a receiver process completion of using a shared memory buffer;
b. decouple a one-phase synchronization mechanism used by the IPC;
c. utilize one or more efficient light-weight synchronization mechanisms for an improved performance, or
d. relax a process parallelism coupling.

11. A system for facilitating an inter-process communication (“IPC”) of a plurality of IPC processes or tools, comprising:
a computer hardware arrangement configured to, using a two-phase synchronization mechanism, share a memory segment between a sender process buffer of a first IPC process or tool and a receiver process buffer of a second IPC process or tool,
wherein the two-phase synchronization mechanism is based on at least one of (i) a completion of the IPC, or (i) a termination of the IPC using the shared memory segment for at least one of a reading procedure or a writing procedure.

12. The system of claim 11, wherein the IPC is configured to exclude data copying.

13. The system of claim 11, wherein the IPC is configured to operate independently from (i) the first IPC process or tool, and (ii) the second IPC process or tool.

14. The system of claim 11, wherein the IPC is configured to operate independently from an underlying application.

15. The system of claim 11, wherein the IPC is configured to operate implement a subset of (i) the first IPC process or tool, and (ii) the second IPC process or tool.

16. The system of claim 11, wherein the IPC is configured to add a functionality to (i) the first IPC process or tool, and (ii) the second IPC process or tool.

17. The system of claim 11, wherein the IPC is configured to implement an IPC standard that is different from a standard of (i) the first IPC process or tool, and (ii) the second IPC process or tool.

18. The system of claim 11, wherein the IPC is configured to at least one:
a. intercept IPC function calls,
b. redirect IPC function calls,
c. redirect IPC function calls to (i) the first IPC process or tool, and (ii) the second IPC process or tool,
d. implement a superset of (i) the first IPC process or tool, and (ii) the second IPC process or tool and redirect function calls to (a) the first IPC process or tool, and (b) the second IPC process or tool so that applications are not aware of redirection process,
e. operate on its own without (i) the first IPC process or tool, and (ii) the second IPC process or tool,
f. require no cross-memory-attach specific system calls,
g. require no embodiment-specific kernel modules,
h. utilize non-specific shared-memory hardware or software arrangements,
i. utilize at least one of physical memory, NUMA memory, reflective memory, or virtualized distributed memory,
j. track, record, analyze, and optimize system operation,
k. implement one or more process optimizations,
l. implement at least one of placement, binding, or priority,
m. implement non-uniform memory access (‘NUMA”) memory optimizations,
n. implement at least one of placement or migration,
o. implement one or more cache memory optimizations, or
p. implement at least one of a physical allocation or a memory bandwidth allocation.

19. The system of claim 11, wherein the sharing the memory procedure at least one:
a. utilizes a shared memory region to hold a single buffer to be used by a sender process and a receiver process for one or more data exchanges,
b. includes a first shared memory region used for the data exchanges by the sender process that overlays an original sender process buffer memory space,
c. includes a second shared memory region used for the data exchanges by the receiver process that overlays an original receiver process buffer memory space,
d. includes a third shared memory region used for exchanges that is overlayed by the sender process and the receiver process concurrently,
e. excludes the sender process and the receiver processes which are not aware of a memory overlay process, or
f. utilizes a reverse process with one or more cross-memory-attach methods, wherein an original user buffer space overlays the shared memory region.

20. The system of claim 11, wherein the two-phase synchronization mechanism is configured to at least one of:
a. implement a separate synchronization event for at least one of a data exchange, a sender process or a receiver process completion of using a shared memory buffer;
b. decouple a one-phase synchronization mechanism used by the IPC;
c. utilize one or more efficient light-weight synchronization mechanisms for an improved performance, or
d. relax a process parallelism.

21. A non-transitory computer-accessible medium having stored thereon computer-executable instructions for facilitating an inter-process communication (“IPC”) of a plurality of IPC processes or tools, wherein, when a computing arrangement executes the instructions, the computing arrangement is configured to perform procedures comprising:
with a two-phase synchronization mechanism, sharing a memory segment between a sender process buffer of a first IPC process or tool and a receiver process buffer of a second IPC process or tool,
wherein the two-phase synchronization mechanism is based on at least one of (i) a completion of the IPC, or (i) a termination of the IPC using the shared memory segment for at least one of a reading procedure or a writing procedure.

22-30. (canceled)
